(19) United States
(12) Patent Application Publication
(10) Pub. No.: US 2022/0162902 A1
(43) Pub. Date: May 26, 2022

(54) SYSTEMS FOR PROVIDING AN IMPACT-RESISTANT WINDOW AND METHODS OF MAKING AND USING THE SAME

(71) Applicant: WINCO Window Company, Inc., St. Louis, MO (US)

(72) Inventors: Kenneth Snader, St. Louis, MO (US); Gantt Miller, III, Minden, NV (US); Woodrow Miller, St. Louis, MO (US)

(21) Appl. No.: 17/100,203

(22) Filed: Nov. 20, 2020

(51) Int. Cl. E06B 3/26

(52) U.S. Cl. CPC E06B 3/2605

(57) ABSTRACT

An impact-resistant window may include features that reduce the forces exerted on the edges of related panes, thereby preventing breakage due to impacts. In a described embodiment, the in pact-resistant window comprises at least one pane made of a transparent material and a frame including a first frame portion, a second frame portion, and a third frame portion. In this embodiment, the connection between the first frame portion and the third frame portion may be configured to allow movement between the first frame portion and the third frame portion.

### BACKGROUND OF THE INVENTION

### 1. Field of the Invention

This disclosure is related to the field of commercial windows. More particularly to windows that may resist impact forces resulting from impacts on the window from sources including a tornado. While the windows discussed herein are primarily discussed with reference to storms and other natural events, the damage they are designed to resist will have a myriad of other applications.

### 2. Description of the Related Art

Buildings have included windows for thousands of years. Windows are an opening made in something that would otherwise be impenetrable—windows have been placed into the walls and roofs of buildings to facilitate the flow of light and air into the building's interior. At first, windows were made as an opening in an otherwise complete structure. These first windows may have been covered by animal hide, cloth, or wood when not in use. Eventually, building designers began to use glass as a covering, which allowed light to enter the building while blocking weather, wind, sound, and other factors external to the buildings. Glass making techniques improved over time, and today entire facades of skyscrapers may be formed of glass panes and aluminum or steel mullions. Further, multiple panes of glass may be used to improve thermal and sound insulation provided by the windows.

Windows are typically relatively frail when compared to other building materials, such as brick, concrete, plaster, steel, wood, and the like. Accordingly, windows may represent a weak spot in an otherwise sturdy facade (or interior) of a building. Glass windows may shatter if subjected to an impact from an external source. Buildings, which, at their base, serve as shelters for persons and things, may be subjected to many impacts from external sources. A common example of buildings being bombarded from an external source is a baseball hitting a home when a game of baseball is being played on a proximate lawn. If the baseball collides with a brick wall, the brick wall is unlikely to be damaged, and almost certainly, the brick wall will not be significantly damaged. However, if the baseball collides with a glass window, the window may shatter if the baseball supplies a sufficient force. Another example of buildings being bombarded may occur during a tornado or other severe wind event. Debris surrounding a building may be transported at great speeds into anything in the path of the tornado's rotating column of wind, including the facades of buildings. Such impacts may be quite severe. Even the pressure from such a wind event may cause a window to break by exerting pressure onto the window. Further, breakage during a wind even may cause additional problems for a related structure, as the pressure difference between the windy exterior and the calm interior may lead to further damage to the structure if a window is compromised.

Some prior windows have been designed to attempt to protect against such impacts and other breaking forces. These prior windows include those designed to use materials other than glass. For example, relatively transparent polymers, such as polycarbonate, have been utilized in the place of glass for the panes of impact-resistant windows. Such polymer panes may be made to be relatively thick and flexible, which may assist in spreading impact forces over a greater amount of window material, lessening the damaging effects of any impact. Other examples include ballistic windows, which typically are particularly resistant to penetration by projectiles. Ballistic windows are typically made from a combination of two or more types of glass (or other transparent material), one hard and one soft. These two different types of glass are typically arranged as a laminate, with two or more alternating layers. The hard material may then be used to spread and slow any incident projectile, while the soft material may absorb energy, typically through deformation. Ballistic windows typically perform well for stopping high-energy projectiles that provide great amounts of pressure at the point of impact. However, such windows may be prohibitively thick, heavy, and expensive, especially where anticipated impacts provide lesser amounts of pressure.

Ballistic and similar impact resistant windows are typically intended to resist point breaks or penetrations. A bullet or other highly pointed object is designed to penetrate through a target and, thus, this type of window is designed to resist such penetration even while the window glass actually breaks around the bullet. This is in similar fashion to other types of windows, such as, but not limited to, windshields and patio doors which are designed primarily to avoid penetration of an object (usually a human head) through them when impacted as opposed to not breaking under the impact. In these circumstances, the integrity of the glass is often not maintained as the glass is often shattered or cracked around the point of impact, but the potentially penetrating object is repulsed from the window.

For windows specifically designed to protect from storm debris, as well as in other similar circumstances, is it is desirable that the integrity of the glass be maintained if at all possible. While a broken windshield will often have prevented penetration by the driver's head impacting it, the broken windshield often falls out of the car readily with only minor force. If glass fails in this way in a storm, pressure differentials and the force of winds can cause the broken pane to easily come apart or come out of its frame creating both a hazard itself, and allowing other storm debris (as well as rain and wind) into the structure. In the end, the failure of the window to maintain integrity, and thus, the integrity of the entire structure, is far more damaging that the window successfully keeping out the initially impacting object.

Improvement in the impact resistance of a window may exist because one mode of window failure is that the free edges (the outer edges) of the pane are typically constrained by the frame and glazing of the window while the actual pane of glass can flex under the impact. When an object is incident upon a pane, the area of the impact may be displaced in the direction of the impact along the thickness (or depth) of the pane with the plane flexing instead of breaking under the impact. This displacement may spread through the pane up to the edges of the pane, typically propagating through the pane in a wave-like manner and dispersing or attenuating as it propagates from the impact point. However, stress will usually develop rapidly at the edges of the pane as the wave moves through the pane to the edges if the pane's edges are constrained by the window frame or glazing. As the frame is typically made of a much more rigid and inflexible material than glass such as, but not limited to, wood or steel, when the displacement of the pane reaches this point, the very strength of the mounting can result in the pane cracking even if the pane had otherwise resisted the impact as the impact wave cannot traverse the juncture between glass and frame. This stress may, thus, lead to the failure, and breakage, of the pane at the edge resulting in a compromise in the integrity of the window that can then result in the window separating from the frame and the integrity of the building it was in being destroyed.

It is known in the art that typical windows may be designed to be relatively large in their height and length to reduce the risk of breakage from incident objects. By enlarging a window along its two larger dimensions (which may be height and width), the peak forces experienced by portions of the window material for a given impact may be diminished by spreading the impact over a larger extent of the window and allowing the displacement wave to dissipate and attenuate before it reaches the frame.

This improvement in the impact resistance of a window may exist because one mode of window failure is that the free edges (the outer edges) of the pane are typically constrained by the frame and glazing of the window. When an object is incident upon a pane, the area of the impact may be displaced in the direction of the impact along the thickness (or depth) of the pane. This displacement may spread through the pane up to the edges of the pane, typically propagating through the pane in a wave-like manner. Stress may develop rapidly at the edges of the pane as the wave moves through the pane to the edges if the pane's edges are constrained. This stress may lead to the failure, and breakage, of the pane.

Unfortunately, enlarging panes may not always be possible. For example, large panes may be more expensive, more difficult to source, or otherwise unfeasible. In other situations, the resulting larger windows may not be appropriate, due to either placement constraints, aesthetic concerns, other design needs, or any other rationale. Further, enlarging a window may not provide sufficient impact resistance even if otherwise feasible.

In some situations, windows may also be formed within the interior of buildings. For example, a door within a building may include a window to allow light to pass between both sides of the door. Such windows may also allow a person on one side of the door to view at least some of the area on the other side of the door. These interior windows are often used in hospitals and other medical facilities where staff would like to be able to view the happenings within rooms of a given facility from outside of those rooms. In some instances, interior windows may be subjected to impacts. For example, in some medical facilities, a given patient may, for a number of reasons, attempt to break (or otherwise strike) interior windows on doors to the room in which the patient is situated. As a further example, some buildings it elude indoor sports facilities, wherein objects may be incident upon, and break, the widow due to the nature of the sport played within the building. It is typically desirable to prevent such breakage, as breakage may increase maintenance costs and related debris may pose a danger to patients, hospital staff, or other building inhabitants. Some windows address these concerns by increasing thickness, using protective films, using protective meshes, or applying other methods. However, these solutions are not always sufficient, cost effective, or desirable.

### SUMMARY

The following is a summary of the invention in order to provide a basic understanding of sonic aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein is a window that may resist the impact forces resulting from impacts on the window from sources including a tornado.

Because of these and other problems in the art, there is described herein, among other things, is an impact-resistant window comprising: at least one pane, which pane is made of a transparent material; a frame comprising; a first frame portion, placed on a first side of the at least one pane; a second frame portion, placed on a second side of the at least one pane; and a third frame portion, placed adjacent to and in contact with the first frame portion; wherein a connection between the first frame portion and the third frame portion is configured to allow movement between the first frame portion and the third frame portion.

In an embodiment of the window, the at least one pane comprises a first subpane and a second subpane.

In an embodiment of the window, the first subpane is a laminated sheet.

In an embodiment of the window, the window further comprises a fourth frame portion, wherein the fourth frame portion is positioned at least between the first frame portion and the second frame portion.

In an embodiment of the window, the fourth frame portion is positioned at least partially between the first subpane and the second subpane.

In an embodiment of the window, the connection between the first frame portion and the third frame portion comprises a fastener and a crush washer.

In an embodiment of the window, the at least one pane comprises a first subpane and a second subpane.

In an embodiment of the window, the first subpane is a laminated sheet.

In an embodiment of the window, the window further comprises a fourth frame portion, wherein the fourth frame portion is positioned at least between the first frame portion and the second frame portion.

In an embodiment of the window, the fourth frame portion is positioned at least partially between the first subpane and the second subpane.

### BRIEF DESCRIPTION OF THE DRAWINGS

FIG. 1 depicts a front side view of an embodiment of an impact-resistant window in accordance with this Application.

FIG. 2 depicts cross-sectional view of the embodiment of an impact-resistant window shown in FIG. 1.

FIG. 3 depicts a cross-sectional view of another embodiment of an impact-resistant window in accordance with this Application.

### DESCRIPTION OF THE PREFERRED EMBODIMENT(S)

This disclosure is focused on impact-resistant windows, as well as methods of using the same. In some embodiments, the impact-resistant windows may include features that reduce the forces exerted on the edges of related panes, thereby preventing breakage due to impacts.

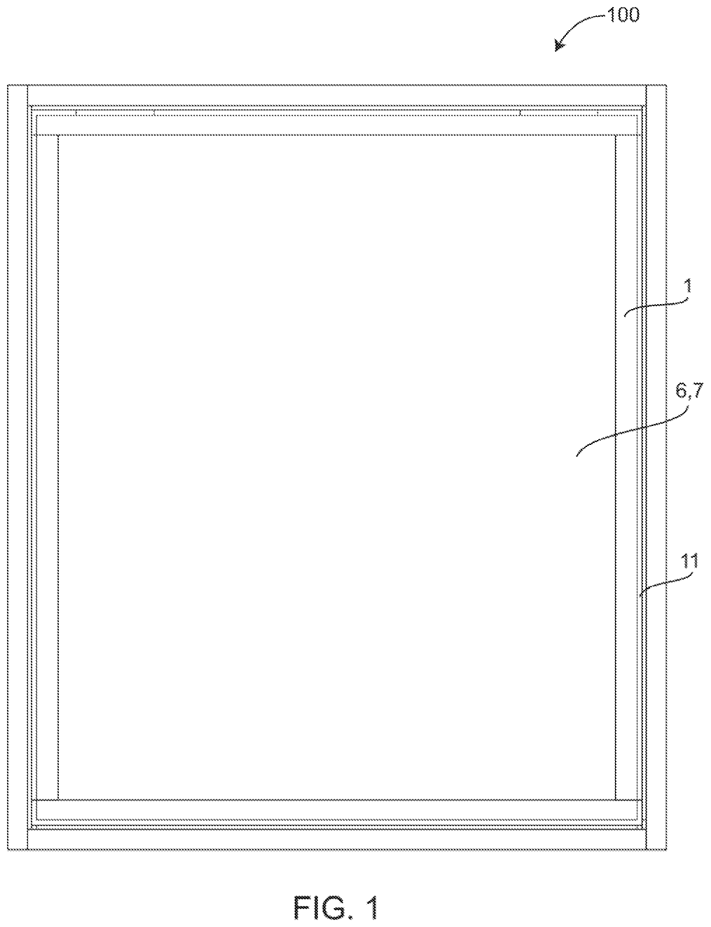

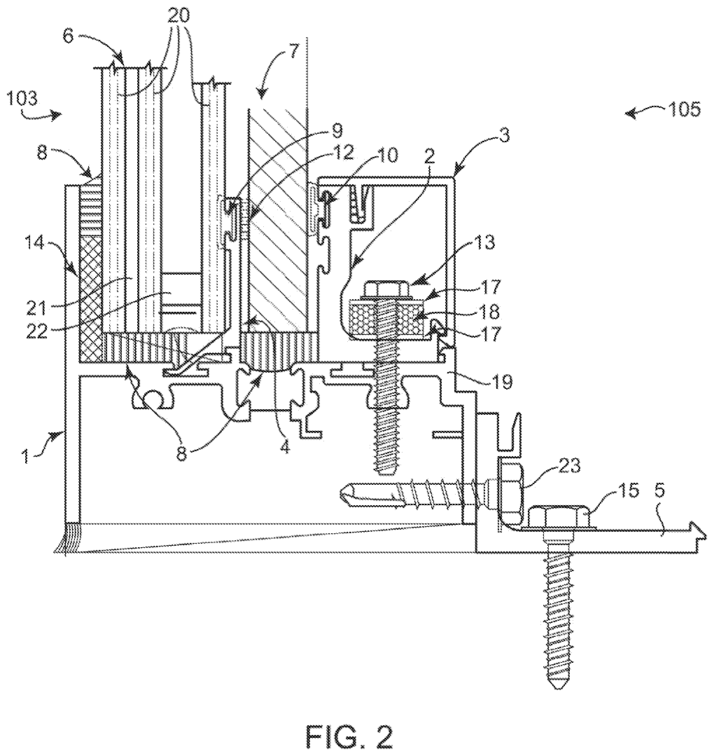

FIGS. 1 and 2 herein depict views of an embodiment of an impact-resistant window (100). As depicted primarily in FIG. 2, the largest structural components of the depicted embodiment of the impact-resistant window (100) may include a fixed frame (1), a first glazing bead (2), a second glazing bead (4), a third glazing bead (19), a first pane (6), and a second pane (7). The first glazing bead (2) and the third glazing bead (19) may be connected together using a first bolt (13) and a crush washer (18), which may be flanked by one or two flat washers (17). This connection may allow for some deflection between the first glazing bead (2) and the third glazing bead (19), which ability to deflect may reduce stresses incident upon the first pane (6) or second pane (7) of the window (100) in the event that the first pane (6) or second pane (7) is subjected to an impact from an object.

FIG. 1 shows a front view of an embodiment of the window (100). As shown, the first pane (6) and second pane (7) may make up a majority of the front area of the window (100). The first pane (6) and second pane (7) may be flanked by a setting (11), which may be made from any material. In some embodiments, the setting (11) may be made from a polymer material, such as a polycarbonate. Although the window (100) in the depicted embodiment has a generally square shape, any shape may be used, as would be understood by persons of ordinary skill in the art.

Any pane discussed herein will typically have a substantially flat shape. Such a shape or structure may be referred to herein as a sheet. Although most pales are substantially flat, the terms “pane” and “sheet” include any other shape that may be used for a window of any type when used in this Application.

FIG. 2 provides a detailed cross-section view of the embodiment of the impact-resistant window (100) shown in FIG. 1, taken along an edge of the window (100). Although this cross-sectional view is intended to generally represent the periphery of the window (100), portions of the window (100) may have varied structures. For example, the areas at the corners of the window (100) may have a different cross-sectional appearance because the relative sizes and extents of some of the pieces of the window (100) may have different lengths and even arrangements. Further, there may be other variations, such as discontinuities for pieces of the window (100), at various portions along the periphery of the window (100). For example, without limitation, any of the pieces of the window (100) discussed herein, such as the glazing bead bulb (9) or the gasket (12), may include some areas of discontinuity around the periphery of the window (100).

As shown in FIG. 2, the window (100) has a front side (103) and a hack side (105). The front side (103) is intended to face towards the exterior of a building if the window (100) is installed in a building's facade, and the back side (105) is intended to face towards the interior of a building. For entirely interior installation of the window (100), any orientation may be used. As shown in FIG. 2, the fixed frame (1) may be positioned on the front side (103) of the window (100), while the first glazing head (2) and the third glazing head (19) may be positioned on the back side (105) of the window (100). The second glazing bead (4) may be positioned between the fixed frame (1) and the first glazing bead (2), as depicted in FIG. 2. The fixed frame (1), first glazing head (2), second glazing head (4), and third glazing bead (19) may be made from any material sufficient for supporting and binding the window (100), and the material for each part may be different or the same across the parts. In some embodiments, the fixed frame (1), first glazing head (2), second glazing bead (4), and third glazing head (19) may each be made from aluminum, steel, a polymer, or similar material. Each of these parts may be made of the same material or different materials. In some embodiments, any of these parts may be made from a composite material.

The window (100) may include the first pane (6) that comprises, generally, at least one generally planar pane (sheet) of glass or other material. In the embodiment depicted in FIG. 2. the first pane (6) includes two or more subpanes of material laminated together to form a laminated material. Each pane may be made from any glass material, or alternatively, from any material known in the art as suitable for use in a window, such as a generally transparent polymer, including polycarbonate. Additionally, any subpane may itself also be made from a laminate of various materials or may be coated with any material known in the industry to be used to treat glass or other generally transparent materials, such as an antireflective coating or a tinting material. In the embodiment depicted in FIG. 2, the first pane (6) comprises three subpanes of high-strength glass (20); a layer of a polymer material (21) formed between two of the subpanes of high-strength glass (20); and a pane spacer (22), which may be formed of any material. Typically, the pane spacer (22) may be made from a polymer rubber, or other flexible and resilient material. Other constructions for the first pane (6) may be used, including, without limitation, a single pane of glass or other generally transparent material.

As shown in FIG. 2, the second pane (7) may also be included in the window (100). Like the first pane (6), the second pane (7) generally comprises at least one generally planar pane (sheet) of glass or other material. Each pane or subpane may be made from any glass material, or alternatively, from any material known in the art as suitable for use in a window, such as a transparent polymer, including polycarbonate. In the embodiment depicted in FIG. 2, the second pane (7) is a relatively thick sheet of polycarbonate.

In some embodiments, the first pane (6) and the second pane (7) may include some additional treatments to assist in providing impact resistance. First, any of the first pane (6) and the second pane (7) may have the sharp corners of its edges substantially de-burred. Further, the edge surfaces of any of the first pane (6) and the second pane (7) may be formed such that the edge surfaces are substantially free of defects (and therefore relatively smooth). This smoothness may be created during the cutting process. Further, or alternatively, the edge surfaces (or sharp corners) may be sanded to improve their smoothness.

The second glazing bead (4) may be formed, at least in part, between the first pane (6) and the second pane (7). As depicted in FIG. 2, the second glazing bead (4) may be positioned to extend under or around the first pane (6) and up between the first pane (6) and the second pane (7). In other embodiments, the second glazing head (4) may have any shape and may be placed anywhere around or between any panes used in the window. In the depicted embodiment, attached to a portion of the second glazing bead (4) between the second glazing bead (4) and the first pane (6) may be a glazing head bulb (9). The glazing bead bulb (9) may be attached to a portion of the second glazing bead (4) near one end of the second glazing bead (4). In other embodiments, the glazing bead bulb (9) may be positioned at any point that is between the second glazing bead (4) and the first pane (6). The glazing bead bulb (9) may be made of any material, including, without limitation, a polymer, rubber, or similar material. In an embodiment wherein only one pane of material is used for the window (100), the second glazing bead (4) may be omitted, along with the glazing bead bulb (9).

A gasket (12) may be formed between the second glazing bead (4) and the second pane (7). In the depicted embodiment, the gasket (12) may be positioned proximate to where the glazing bulb (10) is positioned along the second glazing bead (4). In other embodiments, the gasket (12) may be positioned at any point that is between the second glazing bead (4) and the second pane (7). In other embodiments, especially those that only use a single pane for the window (100), the gasket (12) may be omitted. The gasket (12) may be made of any material. In the embodiment depicted in FIG. 2, the gasket (12) is made from a PVC foam dry tape. In some embodiments, the glazing bulb (9) may be replaced or supplemented with an additional elastic filler, such as, for example, without limitation, PVC foam dry tape.

A second glazing bulb (10) may be formed between the second pane (7) and the first glazing bead (2). The second glazing bead bulb (10) may be attached to a portion of the first glazing bead (2) near one end of the first glazing head (2). In other embodiments, the second glazing bead bulb (10) may be positioned at any point that is between the first glazing head (2) and the second pane (7). The second glazing bead bulb (10) may be made of any material, including, without limitation, a polymer, rubber, or similar material.

The first glazing bead (2) may be connected to a glazing bead cover (3). As depicted, the glazing bead cover (3) may partially surround the first glazing bead (2) and may be connected to the first glazing bead (2) via a friction or snap-in fit. In other embodiments, the glazing bead cover (3) maybe connected to the first glazing bead (2) in any manner. The glazing bead cover (3) and the first glazing bead (2) may enclose the crush washer (18) and the washers (17), as well as portions of the first bolt (13).

The fixed frame (1) may be connected to the first pane (6) via adhesive materials, or via another fastening system, such a screws or bolts. The fixed frame (1) is typically placed on the front side (103) of the window (100). In the depicted embodiment, the fixed frame (1) may be attached to the other portions of the window (100) using glazing tape (14) or a silicone material (8). In some embodiments, the silicone material (8) may be structural silicone. In other embodiments, any fastening system may be used, so long as the connection provides a sufficient level of bonding, some resilience, and some flexibility. Flexible material may prove the impact resistance of the window (100) by allowing for some deflection of the first pane (6) and by absorbing some of the vibration or deflection energy present in the first pane (6).

The second glazing bead (4) may also be connected to the fixed frame (1). In the depicted embodiment, a foot portion of the second glazing bead (4) is connected to a slotted portion of the fixed frame (1). This connection is supplemented by the use of an adhesive (8), such as a silicone material. In other embodiments, any material capable of increasing the strength of the connection between the fixed frame (1) and the second glazing bead (4) may be used as the adhesive. In other embodiments, any fastening system may be used to make the connection, so long as the connection provides a sufficient level of bonding, some resilience, and some flexibility.

On the back side (105) of the window (100) may be a wail install trim (5). This wall install trim (5) may be used to anchor the window (100) to a wall (or other structure, including, without limitation, a door) in which the window (100) is being installed. The wall install trim (5) is typically fastened to the third glazing bead (19). In the depicted embodiment, a second bolt (2) may be used to fasten the wall install trim (5) to the third glazing bead (19). In other embodiments, any other fastening system may be used. The wall install trim (5) may then be fastened to the wall (or other structure). In the depicted embodiment, a third bolt (15) is used to fasten the wall install trim (5) to the wall (or other structure). In other embodiments, any other fastening system may be used.

In the depicted embodiment, the first bolt (13) may be used to secure the first glazing bead (2) to the third glaring bead (19). The crush washer (18) may be used to supply some ability for this connection to deflect and otherwise displace an appreciable amount. This movement may allow for stresses within the window (100) system to be dissipated, as discussed above. The crush washer (18) may be made of any material that may provide some movement of the first glazing bead (2) relative to the third glazing bead (19). For example, without limitation, the crush washer (18) may be made from a rubber, polymer, or other flexible and resilient material. The crush washer (18) may also be referred to as a shock washer.

Other means of allowing this displacement or relative movement to occur may also be used. For example, a spring system may be used in place of the crush washer (18), as would be understood by persons of ordinary shrill in the art. Further, the connection between the first glazing bead (2) to the third glazing bead (19) may have a different placement or orientation in other embodiments. What is most useful is that the glazing bead along the side of the window (100) be able to move somewhat relative to the glazing bead supporting the window in the interior (or otherwise constraining the window). In other embodiments, the third glazing bead (19) may be replaced with a different structure, as long as there is some ability for the first glazing bead (2) to be able to move relative to that different structure. In yet other embodiments, the connections between the first pane (6) or second pane (7) and whatever structure is restraining the panes'(6, 7) ends may be flexible to allow movement of the ends of the panes (6, 7) if an object or other force is incident upon either pane (6, 7).

The deflection or other displacement occurring in the window may be any type of displacement. For example, in some embodiments, the displacement may be the result of a rotation of the first glazing bead (2) relative to the third glazing head (19). Effectively, this may alter the spring rate of the window panes (6, 7) used in the window (100). In some embodiments, this may have the effect of changing the edge conditions of the panes (6, 7) when the window (100) is considered to be a spring system. In some embodiments, these improvements may allow for smaller windows to be used while retaining the impact resistance of larger, prior windows. In other embodiments, these improvements may simply address some concerns with impact resistance of windows.

In yet other embodiments, crush washers may be used with the placement of any bolt or other fastener. For example, a crush washer may be used with each of the first bolt (13), the second bolt (23), the third bolt (15), or any other fastener.

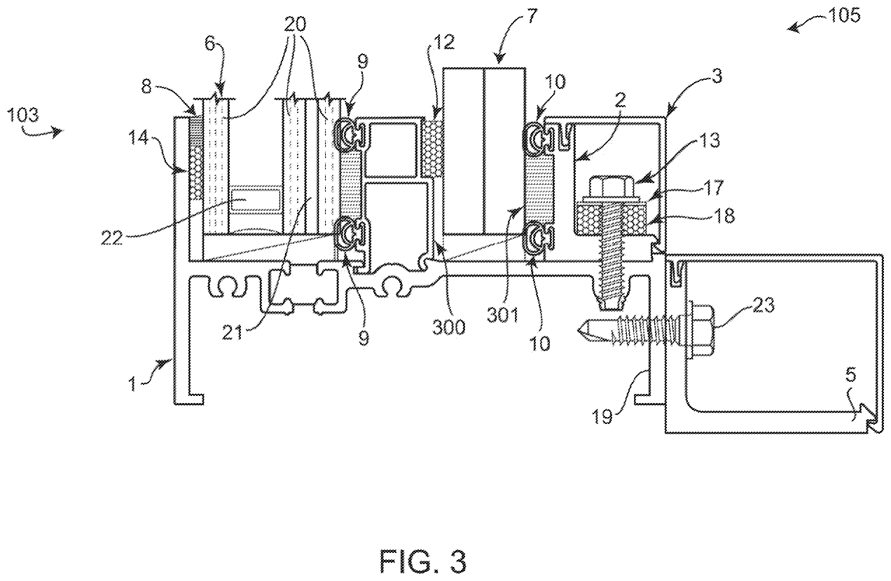

FIG. 3 depicts an additional embodiment of the window (100). Specifically, in this depicted embodiment, the window (100) includes a greater spacing between the window panes (6, 7). Interposed between the window panes (6, 7) may be a spacing glazing head (300). Such a glazing bead may be formed in any manner and in any material, as discussed above with reference to the other glazing beads that may be used in the window (100). In the depicted embodiment, the spacing glazing bead (300) has several different portions, which portions provide some additional spacing between the window panes (6, 7). The spacing glazing bead (300) may be capable of being snapped into place, which may allow for more efficient construction, and may be designed to allow for a controlled application of silicone to assist in construction, as would be known to a person of ordinary skill in the art. This additional spacing, as well as the materials within the spacing, may increase the window's (100) impact resistance.

Further, there may be other additional differences between the embodiments shown in FIG. 3 and in FIG. 2. For example, the depicted embodiment shown in FIG. 3 uses multiples of each of its glazing bulbs (9, 10). This difference, as well as the others shown in FIGS. 2 and 3 may be used in any embodiment of the window (100). Further, a gasket (301) or other bonding or shock-absorbing material may be used between the spacing glazing bead (300) and the first glazing bead (2). In fact, such gaskets may be used between any adjacent portions in any embodiment of the window (100). Moreover, the overall depth of the window (100) may be increased as shown in FIG. 3 when compared to that shown in FIG. 2. The thickness of either or both of the window panes (6, 7) may also be increased in the embodiment shown in FIG. 3 when compared to that shown in FIG. 2, or vice versa.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

Finally, the qualifier “generally,” and similar qualifiers as used in the present case, would be understood by one of ordinary skill in the art to accommodate recognizable attempts to conform a device to the qualified term, which may nevertheless fall short of doing so. This is because terms such as “planar” are purely geometric constructs and no real-world component is a true “planar” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in a view of these and other considerations. Finally, the qualifier “generally” is intended to capture small variations from the qualified term that do not adversely affect the function or purpose of the qualified term. For example, a pane having a slight bow, or small raised bumps, would be considered a pane as used here.

1. An impact-resistant window comprising;
at least one pane, which pane is made of a transparent material;
a frame comprising:
a first frame portion, placed on a first side of the at least one pane;
a second frame portion, placed on a second side of the at least one pane; and
a third frame portion, placed adjacent to and in contact with the first frame portion;
wherein a connection between the first frame portion and the third frame portion is configured to allow movement between the first frame portion and the third frame portion.

2. The impact-resistant window of claim 1, wherein the at least one pane comprises a first subpane and a second subpane.

3. The impact-resistant window of claim 2, wherein the first subpane is a laminated sheet.

4. The impact-resistant window of claim 2, further comprising a fourth frame portion, wherein the fourth frame portion is positioned at least between the first frame portion and the second frame portion.

5. The impact-resistant window of claim 4, wherein the fourth frame portion is positioned at least partially between the first subpane and the second subpane.

6. The impact-resistant window of claim 1, wherein the connection between the first frame portion and the third frame portion comprises a fastener and a crush washer.

7. The impact-resistant window of claim 6, wherein the at least one pane comprises a first subpane and a second subpane.

8. The impact-resistant window of claim 7, wherein the first subpane is a laminated sheet.

9. The impact-resistant window of claim 7, further comprising a fourth frame portion, wherein the fourth frame portion is positioned at least between the first frame portion and the second frame portion.

10. The impact-resistant window of claim 9, wherein the fourth frame portion is positioned at least partially between the first subpane and the second subpane.
